(19) United States
(12) Patent Application Publication
(10) Pub. No.: US 2010/0159301 A1
(43) Pub. Date: Jun. 24, 2010

(54) MEMBRANE/ELECTRODE ASSEMBLY FOR POLYMER ELECTROLYTE FUEL CELL, COATING FLUID FOR FORMING CATALYST LAYER FOR POLYMER ELECTROLYTE FUEL CELL, AND PROCESS FOR PRODUCING MEMBRANE/ELECTRODE ASSEMBLY FOR POLYMER ELECTROLYTE FUEL CELL

(75) Inventor: Toshihiro TANUMA, Chiyoda-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/641,960

(22) Filed: Dec. 18, 2009

(30) Foreign Application Priority Data
Dec. 22, 2008 (JP) 2008-325863

(51) Int. Cl. H01M 8/10; B01J 31/06

(52) U.S. Cl. 429/30; 502/159; 427/115

(57) ABSTRACT

To provide a membrane/electrode assembly in which flooding in a catalyst layer is less likely to occur; a coating fluid for forming a catalyst layer capable of forming a catalyst layer in which flooding is less likely to occur; and a process for producing a membrane/electrode assembly in which flooding in a catalyst layer is less likely to occur.

A membrane/electrode assembly 10 which comprises a first electrode 20 having a catalyst layer 22, a second electrode 30 having a catalyst layer 32 and a polymer electrolyte membrane 40 interposed between the first electrode 20 and the second electrode 30 in a state where it is in contact with the catalyst layers, wherein at least one of the catalyst layer 22 and the catalyst layer 32 is a carbon fiber catalyst layer which contains a carbon supported platinum carrier, carbon fibers having an average fiber diameter of from 5 to 20 μm and a fluorinated ion exchange resin, in a proportion of the carbon fibers of from 60 to 85 mass % to the total amount (100 mass %) of the carbon fibers and the carbon support.

### BACKGROUND OF THE INVENTION

1. Field of the Invention

The present invention relates to a membrane/electrode assembly for a polymer electrolyte fuel cell, a coating fluid for forming a catalyst layer for a polymer electrolyte fuel cell, and a process for producing a membrane/electrode assembly for a polymer electrolyte fuel cell.

2. Discussion of Background

Fuel cells are expected to be widely used, since their power generation efficiency is high, the reaction product is only water in principle, and the load to the environment is small. Among them, a polymer electrolyte fuel cell has a high output density and is therefore expected to be widely used for automobiles or as a distributed power generation system, a portable power generation system or a household cogeneration system.

A polymer electrolyte fuel cell is usually constituted by a cell wherein an electrically conductive separator having gas flow paths formed, is disposed on each side of a membrane/electrode assembly comprising a cathode having a catalyst layer and a gas diffusion layer, an anode having a catalyst layer and a gas diffusion layer, and a polymer electrolyte membrane disposed between the catalyst layer of the cathode and the catalyst layer of the anode.

The catalyst layer of the membrane/electrode assembly is required to suppress clogging (flooding) of pores due to water generated by electrode reaction and condensation of water vapor contained in hydrogen or oxygen and to maintain gas diffusion property. If flooding occurs in the catalyst layer, the power generation performance (e.g. the output voltage) of the membrane/electrode assembly will be decreased.

As a membrane/electrode assembly of which the gas diffusion property in the catalyst layer is maintained, a membrane/electrode assembly which has a catalyst layer containing carbon fibers, wherein the content of the carbon fibers in the catalyst layer is increased from the polymer electrolyte membrane side to the gas diffusion layer side (Patent Document 1).

However, in such a membrane/electrode assembly, the content of the carbon fibers in the catalyst layer is insufficient, and the carbon fibers in the catalyst layer are agglomerated, and accordingly, flooding can not sufficiently be suppressed.

Patent Document 1: JP-A-2006-040633

### SUMMARY OF THE INVENTION

Under these circumstances, the present invention provides a membrane/electrode assembly in which flooding in a catalyst layer is less likely to occur; a coating fluid for forming a catalyst layer capable of forming a catalyst layer in which flooding is less likely to occur; and a process for producing a membrane/electrode assembly in which flooding in a catalyst layer is less likely to occur.

The membrane/electrode assembly for a polymer electrolyte fuel cell of the present invention comprises a first electrode having a catalyst layer, a second electrode having a catalyst layer and a polymer electrolyte membrane interposed between the first electrode and the second electrode in a state where it is in contact with the catalyst layers, wherein at least one of the catalyst layer of the first electrode and the catalyst layer of the second electrode is a carbon fiber catalyst layer which contains a carbon supported platinum catalyst, carbon fibers having an average fiber diameter of from 5 to 20 μm, and a fluorinated ion exchange resin, in a proportion of the carbon fibers of from 60 to 85 mass % to the total amount (100 mass %) of the carbon fibers and the carbon support.

The proportion of platinum in half of the region on the polymer electrolyte membrane side of the carbon fiber catalyst layer is preferably from 60 to 100 mass % of the amount of platinum contained in the entire carbon fiber catalyst layer.

The platinum loading in the carbon fiber catalyst layer is preferably from 0.05 to 0.3 mg/cm².

The coating fluid for forming a catalyst layer for a polymer electrolyte fuel cell of the present invention comprises a carbon supported platinum catalyst, carbon fibers having an average fiber diameter of from 5 to 20 μm, a fluorinated ion exchange resin, and a dispersion medium, wherein the dispersion medium contains a fluorinated solvent.

The fluorinated solvent is preferably 1,1,2,2,3,3,4-heptafluorocyclopentane or 2,2,3,3,3-pentafluoropropanol.

The solid content of the coating fluid for forming a catalyst layer for a polymer electrolyte fuel cell of the present invention is preferably from 10 to 50 mass %.

The process for producing a membrane/electrode assembly for a polymer electrolyte fuel cell of the present invention is a process for producing a membrane/electrode assembly for a polymer electrolyte fuel cell comprising a first electrode having a catalyst layer, a second electrode having a catalyst layer and a polymer electrolyte membrane interposed between the first electrode and the second electrode in a state where it is in contact with the catalyst layers, which comprises applying the coating fluid for forming a catalyst layer for a polymer electrolyte fuel cell of the present invention on the surface of the polymer electrolyte membrane and drying the coating fluid to form at least one of the catalyst layer of the first electrode and the catalyst layer of the second electrode.

In the membrane/electrode assembly for a polymer electrolyte fuel cell of the present invention, flooding in the catalyst layer is less likely to occur.

According to the coating fluid for forming a catalyst layer of the present invention, a catalyst layer in which flooding is less likely to occur can be formed.

According to the process for producing a membrane/electrode assembly for a polymer electrolyte fuel cell of the present invention, a membrane/electrode assembly in which flooding in the catalyst layer is less likely to occur can be produced.

### BRIEF DESCRIPTION OF THE DRAWING

FIG. 1 is a cross sectional view illustrating one embodiment of a membrane/electrode assembly of the present invention.

### DETAILED DESCRIPTION OF THE PREFERRED EMBODIMENTS

In the present specification, repeating units represented by the formula (1) will be referred to as units (1). The same applies to repeating units represented by other formulae. The repeating units mean units derived from a monomer, formed by polymerization of such a monomer. The repeated units may be units formed directly by a polymerization reaction, or may be such that some of such units are converted to another structure by treatment of the polymer.

Further, in the present specification, a compound represented by the formula (2) will be referred to as a compound (2). The same applies to compounds represented by other formulae.

### <Membrane/Electrode Assembly>

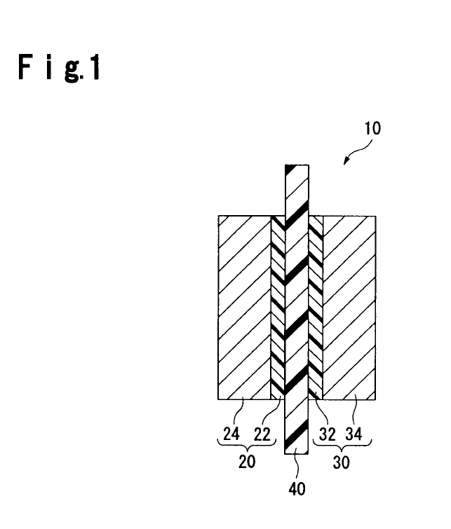

FIG. 1 is a cross sectional view illustrating one embodiment of a membrane/electrode assembly for a polymer electrolyte fuel cell of the present invention (hereinafter referred to as a membrane/electrode assembly). A membrane/electrode assembly 10 comprises a first electrode 20 having a catalyst layer 22 and a gas diffusion layer 24; a second electrode 30 having a catalyst layer 32 and a gas diffusion layer 34; and a polymer electrolyte membrane 40 interposed between the catalyst layer 22 of the first electrode 20 and the catalyst layer 32 of the second electrode 30.

The first electrode 20 may be an anode or a cathode. The second electrode 30 is a cathode when the first electrode 20 is an anode, and is an anode when the first electrode 20 is a cathode.

### (Catalyst Layer)

At least one of the catalyst layer 22 and the catalyst layer 32 (hereinafter generally referred to as a catalyst layer) is a carbon fiber catalyst layer (hereinafter referred to as a CF catalyst layer) which contains a carbon supported platinum catalyst, carbon fibers having an average fiber diameter of from 5 to 20 μm and a fluorinated ion exchange resin, in a proportion of the carbon fibers of from 60 to 85 mass % to the total amount (100 mass %) of the carbon fibers and the carbon support.

In a case where only one of the catalyst layer 22 and the catalyst layer 32 is the CF catalyst layer, the CF catalyst layer is preferably a catalyst layer on the cathode side.

The catalyst layer 22 and the catalyst layer 32 may be layers having the same components, composition, thickness, etc. or different layers.

### (CF Catalyst Layer)

The CF catalyst layer may have a monolayer structure consisting of one layer or may have a laminated structure consisting of two or more layers. In the case of the laminated structure, one or more layers may contain no catalyst nor carbon fibers so long as all the layers contain at least a fluorinated ion exchange resin.

The catalyst contained in the CF catalyst layer is a carbon supported platinum catalyst.

The carbon support may, for example, be activated carbon or carbon black, and it is preferably graphitized by e.g. heat treatment, since its chemical durability is high.

The specific surface area of the carbon support is preferably at least 200 m²/g. The specific surface area of the carbon support is measured by nitrogen absorption using the BET method.

The proportion of platinum in the carbon supported platinum catalyst (100 mass %) is preferably from 10 to 70 mass %.

The carbon fibers contained in the CF catalyst layer may, for example, be PAN carbon fibers or pitch carbon fibers.

As the form of the carbon fibers, chopped fibers or milled fibers may, for example, be mentioned.

The average fiber diameter of the carbon fibers contained in the CF catalyst layer is from 5 to 20 μm, preferably from 6 to 15 μm, more preferably from 6 to 12 μm. When the average fiber diameter of the carbon fibers is at least 5 μm, flooding in the CF catalyst layer can sufficiently be suppressed. When the average fiber diameter of the carbon fibers is at most 20 μm, the carbon fibers can stably be dispersed by a dispersion method according to the present invention.

The fluorinated ion exchange resin contained in the CF resin layer is preferably a perfluorocarbon polymer having ion exchange groups (which may contain an etheric oxygen atom), from the viewpoint of the durability. As such a perfluorocarbon polymer, polymer (H) or polymer (Q) is preferred.

Polymer (H):

The polymer (H) is a copolymer having units based on tetrafluoroethylene (hereinafter referred to as TFE) and units (1).

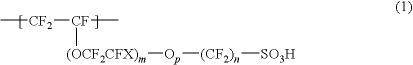

wherein X is a fluorine atom or a trifluoromethyl group, m is an integer of from 0 to 3, n is an integer of from 1 to 12, and p is 0 or 1.

The polymer (H) is obtainable by polymerizing a mixture of TFE and a compound (2) to obtain a precursor polymer (hereinafter referred to as polymer (F)), and then converting the —SO₂F groups in the polymer (F) to sulfonic acid groups. The conversion of the —SO₂F groups to the sulfonic acid groups is carried out by hydrolysis and treatment for conversion to an acid-form.

CF₂═CF(OCF₂CFX)ₘ—Oₚ—(CF₂)ₙ—SO₂F (2)

wherein X is a fluorine atom or a trifluoromethyl group, m is an integer of from 0 to 3, n is an integer of from 1 to 12, and p is 0 or 1.

As the compound (2), compounds (21) to (23) are preferred.

CF₂═CFO(CF₂)ₙ₁SO₂F (21)

CF₂═CFOCF₂CF(CF₃)O(CF₂)ₙ₂SO₂F (22)

CF₂═CF(OCF₂CF(CF₃))ₘ₃O(CF₂)ₙ₃SO₂F (23)

wherein each of n1, n2 and n3 is an integer of from 1 to 8, and m3 is an integer of from 1 to 3.

Polymer (Q):

The polymer (Q) is a copolymer having units based on TFE and units (U1).

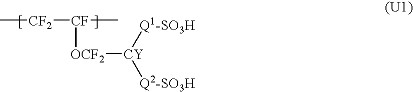

wherein Q¹ is a perfluoroalkylene group which may have an etheric oxygen atom, Q² is a single bond or a perfluoroalkylene group which may have an etheric oxygen atom, and Y is a fluorine atom or a monovalent perfluoro organic group.

The single bond means that the carbon atom of CY is directly bonded to the sulfur atom of SO₃H.

The organic group means a group containing at least one carbon atom.

In a case where the perfluoroalkylene group for Q¹ or Q² has an etheric oxygen atom, the number of such oxygen atoms may be one or more. Further, such an oxygen atom may be inserted in a carbon atom-carbon atom bond of the perfluoroalkylene group, or may be inserted at the terminal of a carbon atom bond.

The perfluoroalkylene group preferably has from 1 to 6 carbon atoms, and it may be linear or branched.

The units (U1) are preferably units (M1), more preferably units (M11) or units (M12).

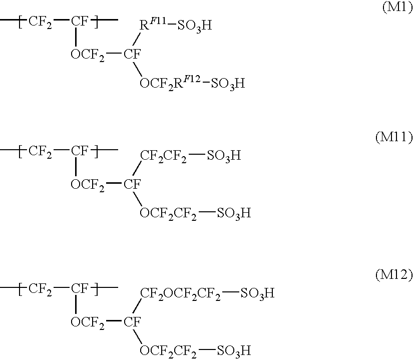

wherein R^{F11} is a single bond or a C₁₋₆ linear perfluoroalkylene group which may have an etheric oxygen atom, and R^{F12} is a C₁₋₆ linear perfluoroalkylene group.

The polymer (Q) may further have repeating units base on other monomer (hereinafter referred to as other units).

Such other units are preferably repeating units based on a perfluoromonomer, more preferably the above-described units (1) having a functional group or units (M2), from the viewpoint of the mechanical strength and chemical durability. The units (M2) are preferably units (M21) or units (M22).

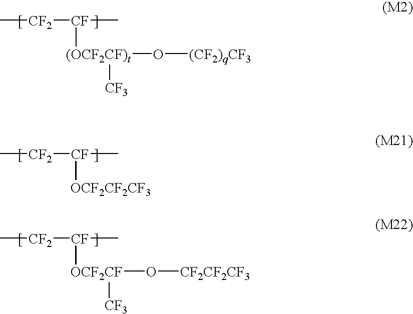

wherein t is an integer of from 0 to 5, and q is an integer of from 1 to 12.

EW of the polymer (Q) is preferably from 400 to 900 g dry resin/equivalent (hereinafter referred to as g/equivalent), more preferably from 500 to 800 g/equivalent.

The mass average molecular weight of the polymer (Q) is preferably from 1×10⁴ to 1×10⁷, more preferably from 5×10⁴ to 5×10⁶.

The mass average molecular weight of the polymer (Q) can be evaluated by measuring the TQ value. The TQ value (unit: ° C.) is an index of the molecular weight of a polymer and is a temperature when the extruded amount would be 100 mm³/sec when melt extrusion of a polymer is carried out under an extrusion pressure condition of 2.94 MPa by using a nozzle having a length of 1 mm and an inner diameter of 1 mm. For example, with a polymer having a TQ value of from 200 to 300° C., its mass average molecular weight corresponds to from 1×10⁵ to 1×10⁶, although it may vary depending upon the composition of repeating units constituting the polymer.

The ion exchange capacity of the fluorinated ion exchange resin is preferably from 1.1 to 1.8 meq/g dry resin, more preferably from 1.25 to 1.65 meq/g dry resin, from the viewpoint of the electrical conductivity and gas diffusion property.

The mass ratio (F/C) of the fluorinated ion exchange resin (F) to the carbon (C) (the carbon fibers and the carbon support) in the CF catalyst layer is preferably from 0.4 to 1.6, more preferably from 0.6 to 1.2, from the viewpoint of the power generation performance of a fuel cell.

In the CF catalyst layer, the proportion of the carbon fibers is from 60 to 85 mass %, preferably from 65 to 80 mass %, more preferably from 65 to 78 mass % to the total amount (100 mass %) of the carbon fibers and the carbon support. When the proportion of the carbon fibers is at least 60 mass %, flooding in the CF catalyst layer can sufficiently be suppressed. When the proportion of the carbon fibers is at most 85 mass %, the power generation performance of a fuel cell will not significantly be impaired.

The proportion of platinum in half of the region on the polymer electrolyte membrane side of the CF catalyst layer, is preferably from 60 to 100 mass %, more preferably from 70 to 100 mass %, furthermore preferably from 80 to 100 mass %, of the amount of platinum contained in the entire CF catalyst layer. By localizing platinum on the polymer electrolyte membrane side of the CF catalyst layer, the platinum loading in the CF catalyst layer can be reduced while the power generation performance of a fuel cell is maintained.

In a case where platinum is localized on the polymer electrolyte membrane side of the CF catalyst layer, the platinum loading in the CF catalyst layer is preferably from 0.05 to 0.3 mg/cm², more preferably from 0.1 to 0.25 mg/cm². When the platinum loading is at least 0.05 mg/cm², the power generation performance of a fuel cell will not remarkably be impaired. When the platinum loading is at most 0.3 mg/cm², there is a good chance of applying fuel cells to automobiles, which requires a high cost performance.

The thickness of the CF catalyst layer is preferably at most 20 μm, more preferably from 1 to 15 μm, whereby the gas diffusion in the CF catalyst layer will be easy, and the power generation performance of a polymer electrolyte fuel cell will be improved. Further, the thickness of the catalyst layer is preferably uniform.

The thickness of the CF catalyst layer is measured by observing a cross section of the CF catalyst layer using e.g. a scanning electron microscope (hereinafter referred to as SEM).

### (Other Catalyst Layer)

In a case where only one of the catalyst layer 22 and the catalyst layer 32 is the CF catalyst layer, the other may be a known catalyst layer (hereinafter referred to as other catalyst layer).

Such other catalyst layer is a layer containing a catalyst and an ion exchange resin.

The catalyst may be any catalyst so long as it is one to accelerate an oxidation/reduction reaction in a fuel cell, and it is preferably a catalyst containing platinum, more preferably a carbon supported platinum or platinum alloy catalyst.

The platinum alloy is preferably an alloy of platinum with at least one metal selected from the group consisting of platinum group metals excluding platinum (such as ruthenium, rhodium, palladium, osmium and iridium), gold, silver, chromium, iron, titanium, manganese, cobalt, nickel, molybdenum, tungsten, aluminum, silicon, zinc and tin. Such a platinum alloy may contain an intermetallic compound of platinum and a metal to be alloyed with platinum.

The proportion of platinum or a platinum alloy in the catalyst (100 mass %) is preferably from 10 to 70 mass %.

The ion exchange resin is preferably a fluorinated ion exchange resin, more preferably a perfluorocarbon polymer having ionic groups (which may contain an etheric oxygen atom), from the viewpoint of the durability. As such a perfluorocarbon polymer, the above described polymer (H) or polymer (Q) is preferred.

In other catalyst layer, the mass ratio (F/C) of the fluorinated ion exchange resin (F) to the carbon (C) (carbon support) is preferably from 0.4 to 1.6, more preferably from 0.6 to 1.2, from the viewpoint of the power generation performance of a fuel cell.

The platinum loading in other catalyst layer is preferably from 0.01 to 0.5 mg/cm² from the viewpoint of the optimum thickness to carry out the electrode reaction efficiently, more preferably from 0.05 to 0.35 mg/cm² from the viewpoint of the balance of the cost of materials and performance.

The thickness of other catalyst layer is preferably at most 20 μm, more preferably from 1 to 15 μm, with a view to facilitating the gas diffusion in other catalyst layer and improving the power generation performance of a polymer electrolyte fuel cell. Further, the thickness of other catalyst layer is preferably uniform.

The thickness of other catalyst layer is measured by observing a cross section of other catalyst layer by e.g. SEM.

### (Gas Diffusion Layer)

The gas diffusion layer 24 and the gas diffusion layer 34 (hereinafter generally referred to as a gas diffusion layer) are a layer made of a gas diffusion substrate. The gas diffusion layer 24 and the gas diffusion layer 34 may be layers having the same components, composition, thickness, etc. or different layers.

The gas diffusion substrate may, for example, be a carbon paper, a carbon cloth or a carbon felt.

The thickness of the gas diffusion layer is preferably from 100 to 400 μm, more preferably from 120 to 300 μm.

The thickness of the gas diffusion layer is calculated by measuring thicknesses at 4 portions using a Digimatic Indicator (manufactured by MITSUTOYO CORPORATION, 543-250, flat measuring terminal: 5 mm in diameter) and obtaining the average of them.

### (Microporous Layer)

The membrane/electrode assembly of the present invention may have a microporous layer (not shown) containing carbon particles and a binder between the catalyst layer and the gas diffusion layer.

By providing a microporous layer comprising carbon particles as the main component between the catalyst layer and the gas diffusion layer, water tends to scarcely clog the pores of the gas diffusion layer, whereby deterioration of the gas diffusion property can be suppressed.

The carbon particles contained in the microporous layer may, for example, be carbon black or carbon fibers.

The binder contained in the microporous layer is preferably a water repellent fluoropolymer, particularly preferably polytetrafluoroethylene (hereinafter referred to as PTFE).

The microporous layer may be provided for each of the first electrode 20 and the second electrode 30 or may be provided for one of the first electrode 20 and the second electrode 30. In a case where one of the first electrode 20 and the second electrode 30 has a microporous layer and the other has no microporous layer, it is preferred that the electrode to be the cathode has the microporous layer.

### (Polymer Electrolyte Membrane)

The polymer electrolyte membrane 40 is a membrane made of an ion exchange resin.

The ion exchange resin is preferably a fluorinated ion exchange resin from the viewpoint of the durability, more preferably a perfluorocarbon polymer having ionic groups (which may have an etheric oxygen atom), further preferably the above described polymer (H) or polymer (Q).

The ion exchange capacity of the fluorinated ion exchange resin is preferably from 0.5 to 2.0 meq/g dry resin, particularly preferably from 0.8 to 1.5 meq/g dry resin.

The thickness of the polymer electrolyte membrane 40 is preferably from 10 to 30 μm, more preferably from 15 to 25 μm. When the thickness of the polymer electrolyte membrane 40 is at most 30 μm, it is possible to suppress a deterioration of the power generation performance of a polymer electrolyte fuel cell under a low humidity condition. Further, when the thickness of the polymer electrolyte membrane 40 is at least 10 μm, leakage of gas or electrical short circuting will be suppressed.

The thickness of the polymer electrolyte membrane 40 is measured by observing a cross section of the polymer electrolyte membrane 40 by e.g. SEM.

In the above described membrane/electrode assembly 10, at least one of the catalyst layer 22 of the first electrode 20 and the catalyst layer 32 of the second electrode 30 is a CF catalyst layer which contains a carbon supported platinum catalyst, carbon fibers having an average fiber diameter of from 5 to 20 μm and a fluorinated ion exchange resin, in a proportion of the carbon fibers of from 60 to 85 mass % to the total amount (100 mass %) of the carbon fibers and the carbon support. Accordingly, a fuel gas will be smoothly supplied, and flooding in the CF catalyst layer is less likely to occur. Thus, the power generation performance of the membrane/electrode assembly 10 is less likely to be deteriorated.

### <Process for Producing Membrane/Electrode Assembly>

The process for producing a membrane/electrode assembly of the present invention is a process which comprises applying a coating fluid for forming a catalyst layer for a polymer electrolyte fuel cell of the present invention as described hereinafter (hereinafter referred to as a coating fluid for forming a catalyst layer of the present invention) on the surface of a polymer electrolyte membrane and drying the coating fluid to form at least one of the catalyst layer of the first electrode and the catalyst layer of the second electrode.

As the process for producing the membrane/electrode assembly 10, for example, the following processes (I) and (II) may be mentioned.

Process (I):

A process of carrying out the following steps (I-1) to (I-3) in order.

(I-1) A step of applying a coating fluid for forming a catalyst layer for a polymer electrolyte fuel cell (hereinafter referred to as a coating fluid for forming a catalyst layer) on the surface of a polymer electrolyte membrane and drying it to form a catalyst layer thereby to obtain a laminate (L) having a catalyst layer formed on one side of the polymer electrolyte membrane.

(I-2) A step of applying a coating fluid for forming a catalyst layer on the surface of a gas diffusion substrate and drying it to form a catalyst layer thereby to obtain an electrode (E) having a catalyst layer formed on one side of the gas diffusion substrate.

(I-3) A step of bonding the electrode (E) to one side of the laminate (L) so that the polymer electrolyte membrane of the laminate (L) is in contact with the catalyst layer of the electrode (E) and bonding a gas diffusion substrate on the other side of the laminate (L).

Process (II):

A process of carrying out the following steps (II-1) and (II-2) in order.

(II-1)A step of obtaining a membrane/catalyst layer assembly having a catalyst layer formed on both sides of a polymer electrolyte membrane in such a manner that a coating fluid for forming a catalyst layer is applied on the surface of a polymer electrolyte membrane and dried to form a catalyst layer, and this operation is repeatedly carried out twice in total.

(II-2) A step of bonding gas diffusion substrates with both sides of the membrane/catalyst layer assembly.

In the process (I), at least the coating fluid for forming a catalyst layer applied on the surface of the polymer electrolyte membrane is the coating fluid for forming a catalyst layer of the present invention described hereinafter.

In the process (II), at least one coating fluid for forming a catalyst layer applied on the surface of the polymer electrolyte membrane is the coating fluid for forming a catalyst layer of the present invention described hereinafter.

In a case where the catalyst layer has a laminated structure, coating fluids for forming a catalyst layer differing in the composition may be used for the respective layers.

As the coating method, a known method may be employed.

The drying temperature is preferably from 40 to 130° C.

The bonding method may, for example, be a hot pressing method, a hot roll pressing method or an ultrasonic fusion method, and a hot pressing method is preferred from the viewpoint of the in-plane uniformity.

The temperature of the pressing plate in the pressing machine is preferably from 100 to 150° C.

The pressing pressure is preferably from 0.5 to 4.0 MPa.

### (Coating Fluid for Forming a Catalyst Layer)

The coating fluid for forming a catalyst layer of the present invention comprises a carbon supported platinum catalyst, carbon fibers having an average fiber diameter of from 5 to 20 μm, a fluorinated ion exchange resin and a dispersion medium.

The dispersion medium contains a fluorinated solvent, whereby the carbon fibers can uniformly be dispersed.

The fluorinated solvent may, for example, be a fluorinated aliphatic hydrocarbon (such as 1,1,2,2,3,3,4-heptafluorocyclopentane, 1,3-dichloro-1,1,2,2,3-pentafluoropropane, 1,1-dichloro-2,2,3,3,3-pentafluoropropane, 1,1,1,2,3,4,4,5,5,5-decafluoropentane or 1,1,1-trichloro-2,2,3,3,3-pentafluoropropane) or an after-mentioned fluorinated alcohol, and particularly preferred is 1,1,2,2,3,3,4-heptafluorocyclopentane or 2,2,3,3,3-pentafluoro-1-propanol, with a view to maintaining a dispersed state of the carbon fibers for a long period of time.

The dispersion medium may contain other dispersion medium.

Such other dispersion medium may be an organic solvent or water, and a combination of an alcohol with water is preferred.

The alcohol may, for example, be a non-fluorinated alcohol (such as methanol, ethanol, 1-propanol or 2-propanol) or a fluorinated alcohol (such as 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol or 3,3,4,4,5,5,6,6,7,7,8,8,8-tridecafluoro-1-octanol).

The proportion of the fluorinated solvent is preferably from 2 to 40 mass %, more preferably from 10 to 30 mass % per 100 mass % of the dispersion medium. When the proportion of the fluorinated solvent is at least 2 mass %, a dispersed state of the carbon fibers can be maintained for a long period of time. When the proportion of the fluorinated solvent is at most 40 mass %, the viscosity of the coating fluid will be proper and favorable coating properties will be obtained.

The proportion of the alcohol is preferably from 40 to 80 mass %, more preferably from 50 to 70 mass % per 100 mass % of the dispersion medium. When the proportion of the alcohol is at least 40 mass %, the alcohol will be uniformly mixed with other dispersion medium components (water, fluorinated solvent), and a dispersed state of the carbon fibers will be favorable. When the proportion of the alcohol is at most 80 mass %, the viscosity of the coating fluid will be proper, and favorable coating properties will be obtained.

The proportion of water is preferably from 5 to 40 mass %, more preferably from 10 to 30 mass % per 100 mass % of the dispersion medium. When the proportion of water is at least 5 mass %, the viscosity of the coating fluid will be proper, and favorable coating properties will be obtained. When the proportion of water is at most 40 mass %, the dispersion properties of the carbon fibers will be favorable.

The solid content of the coating fluid for forming a catalyst layer of the present invention is preferably from 10 to 50 mass %, more preferably from 20 to 40 mass %, furthermore preferably from 25 to 35 mass %. When the solid content is at least 10 mass %, the viscosity of the coating fluid will be proper, and favorable coating properties will be obtained. When the solid content is at most 50 mass %, the dispersed state of the carbon fibers can be maintained for a long period of time.

The proportion of the carbon fibers and the carbon support contained in the coating fluid for forming a catalyst layer of the present invention may be properly adjusted depending on the structure (the monolayer structure or the laminated structure) of the CF catalyst layer. In a case where the CF catalyst layer has a monolayer structure, the proportion of the carbon fibers is from 60 to 85 mass % to the total amount (100 mass %) of the carbon fibers and the carbon support. In a case where the CF catalyst layer has a laminated structure, the proportion of the carbon fibers is from 60 to 85 mass % to the total amount (100 mass %) of the carbon fibers and the carbon support in the entire CF catalyst layer, and the proportion of the carbon fibers and the carbon support contained in the coating fluid for forming a catalyst layer used to form each catalyst layer may be out of the above range.

Further, in a case where the CF catalyst layer has a laminated structure, for the purpose of localizing platinum in the polymer electrolyte membrane side of the CF catalyst layer, a coating fluid for forming a catalyst layer containing no catalyst may be used as a coating fluid for forming a catalyst layer to form a layer on the gas diffusion layer side.

With the above described coating fluid for forming a catalyst layer of the present invention, the dispersibility of the carbon fibers will be favorable since the dispersion medium contains a fluorinated solvent. Accordingly, even when the amount of the carbon fibers is increased, favorable dispersibility of the carbon fibers can be maintained and as a result, a CF catalyst layer having a large amount of carbon fibers uniformly dispersed can be formed. In such a CF catalyst layer, a fuel gas is excellently diffused, and flooding is less likely to occur.

Further, in the above described process for producing a membrane/electrode assembly of the present invention, the coating fluid for forming a catalyst layer of the present invention is applied on the surface of a polymer electrolyte membrane and dried to form at least one of the catalyst layer of the first electrode and the catalyst layer of the second electrode. Accordingly, a membrane/electrode assembly in which flooding in the catalyst layer is less likely to occur can be produced.

### <Polymer Electrolyte Fuel Cell>

The membrane/electrode assembly of the present invention is used for a polymer electrolyte fuel cell. The polymer electrolyte fuel cell is, for example, one wherein cells each comprising the membrane/electrode assembly and a pair of separators disposed so that the membrane/electrode assembly is interposed between them, are stacked so that the membrane/electrode assemblies and the separators are alternately disposed.

A separator is one having a plurality of grooves formed to constitute gas flow paths on each side.

The separators may be separators made of various electrically conductive materials, such as separators made of metal, separators made of carbon, or separators made of a mixed material of graphite and a resin.

Types of the polymer electrolyte fuel cell may, for example, be a hydrogen/oxygen type fuel cell, and a direct methanol type fuel cell (DMFC).

### EXAMPLES

Now, the present invention will be described in further detail with reference to Examples. However, it should be understood that the present invention is by no means restricted to such specific Examples.

### Examples 1 to 3 are Comparative Examples, and Examples 4 to 12 are Examples of the present invention.

### (Average Fiber Diameter)

The average fiber diameter of the carbon fibers contained in each coating fluid was calculated in such a manner that a coating fluid was applied on a polyethylene terephthalate film with an applicator and dried to form a coating film (catalyst layer) having a thickness of 50 μm, the coating film was observed using a microscope (manufactured by KEYENCE CORPORATION, digital microscope VHX-900), fiber diameters of 30 carbon fibers randomly selected in a microscope image were measured, and their average was obtained.

The average fiber diameter of the carbon fibers contained in each layer is the same as the average fiber diameter of the carbon fibers contained in the coating fluid used to form the layer.

### (Flooding Preventive Effect)

A membrane/electrode assembly was assembled into a power generation cell, hydrogen (utilization ratio: 50%)/ air (utilization ratio: 50%) were supplied under normal pressure, and cell voltages at the initial stage of operation at a cell temperature of 80° C. under electric current densities of 0.2 A/cm² and 1.5 A/cm² were measured to confirm the power generation performance of the cell and the degree of the decrease in the voltage by flooding were confirmed. Here, hydrogen having a view point of 80° C. was supplied to the anode side, and the air having a dew point of 80° C. was supplied to the cathode side.

### (Polymer (H1) Dispersion)

Polymer (H1) (ion exchange capacity: 1.1 meq/g dry resin) comprising units based on TFE and repeating units represented by the following formula (1-1) was dispersed in a mixed dispersion medium of ethanol and water (ethanol/water=60/40 (mass ratio)) to prepare a polymer (H1) dispersion having a solid content of 28 mass %.

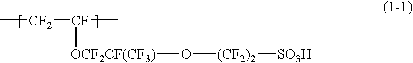

(Coating Fluid (a1) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 50 mass % of the entire mass of the catalyst, 58.9 g of distilled water, 56.8 g of ethanol and 14.3 g of the polymer (H1) dispersion were added, and well dispersed and mixed by a homogenizer to obtain a coating fluid (a1) for forming a catalyst layer.

(Coating Fluid (b1) for Forming a Catalyst Layer)

10.0 g of carbon fibers (manufactured by Showa Denko K.K., VGCF-H, fiber diameter: 0.15 μm) were added to 2.1 g of distilled water and well stirred. 26.6 g of ethanol was added thereto and well stirred. 10.7 g of the polymer (H1) dispersion and 15.6 g of 1,1,2,2,3,3,4-heptafluorocyclopentane (manufactured by ZEON CORPORATION, ZEORORA H) were added thereto, mixed and crushed by a homogenizer to obtain a coating fluid (b1) for forming a catalyst layer.

(Coating Fluid (b2) for Forming a Catalyst Layer)

10.0 g of carbon fibers (manufactured by Showa Denko K.K., VGCF-H, fiber diameter: 0.15 μm) were added to 33.8 g of distilled water and well stirred. 32.2 g of ethanol was added thereto and well stirred. 10.7 g of the polymer (H1) dispersion was added thereto, mixed and crushed by a homogenizer to obtain a coating fluid (b2) for forming a catalyst layer.

(Coating Fluid (b3) for Forming a Catalyst Layer)

10.0 g of carbon fibers (manufactured by Mitsubishi Plastics, Inc., Dialead K223QG, fiber diameter: 11 μm) were added to 2.1 g of distilled water and well stirred. 26.6 g of ethanol was added thereto and well mixed. 10.7 g of the polymer (H1) dispersion and 15.6 g of 1,1,2,2,3,3,4-heptafluorocyclopentane (manufactured by ZEON CORPORATION, ZEORORA H) were added, mixed and crushed by a homogenizer to obtain a coating fluid (b3) for forming a catalyst layer.

(Coating Fluid (b4) for Forming a Catalyst Layer)

10.0 g of carbon fibers (manufactured by Mitsubishi Plastics, Inc., Dialead K223QG, fiber diameter: 11 μm) were added to 4.3 g of distilled water and well stirred. 39.6 g of ethanol was added thereto and well mixed. 10.7 g of the polymer (H1) dispersion and 22.1 g of 1,1,2,2,3,3,4-heptafluorocyclopentane (manufactured by ZEON CORPORATION, ZEORORA H) were added, mixed and crushed by a homogenizer to obtain a coating fluid (b4) for forming a catalyst layer.

(Coating Fluid (b5) for Forming a Catalyst Layer)

10.0 g of carbon fibers (manufactured by Toray Industries, Inc., MLD30, fiber diameter: 7 μm) were added to 4.3 g of distilled water and well stirred. 39.6 g of ethanol was added thereto and well stirred. 10.7 g of the polymer (H1) dispersion and 22.1 g of 1,1,2,2,3,3,4-heptafluorocyclopentane (manufactured by ZEON CORPORATION, ZEORORA H) were added, mixed and crushed by a homogenizer to obtain a coating fluid (b5) for forming a catalyst layer.

(Coating Fluid (c1) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 39 mass % of the entire mass of the catalyst, and 3.1 g of carbon fibers (manufactured by Showa Denko K.K., VGCF-H, fiber diameter: 0.15 μm), 0.8 g of distilled water, 37.4 g of ethanol and 25.3 g of the polymer (H1) dispersion were added in a nitrogen atmosphere, mixed and crushed by a homogenizer. Then, 24.2 g of 1,1,2,2,3,3,4-heptafluorocyclopentane (manufactured by ZEON CORPORATION, ZEORORA H) was added, and well dispersed and mixed by a homogenizer to obtain a coating fluid (c1) for forming a catalyst layer.

(Coating Fluid (c2) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 57 mass % of the entire mass of the catalyst, and 11.7 g of carbon fibers (manufactured by Mitsubishi Plastics, Inc., Dialead K223QG, fiber diameter: 11 μm), 3.7 g of distilled water, 58.9 g of ethanol and 28.1 g of the polymer (H1) dispersion were added in a nitrogen atmosphere, mixed and crushed by a homogenizer. Then, 35.5 g of 1,1,2,2,3,3,4-heptafluorocyclopentane (manufactured by ZEON CORPORATION, ZEORORA H) was added, and well dispersed and mixed by a homogenizer to obtain a coating fluid (c2) for forming a catalyst layer.

(Coating Fluid (c3) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 34 mass % of the entire mass of the catalyst, and 1.0 g of carbon fibers (manufactured by Mitsubishi Plastics, Inc., Dialead K223QG, fiber diameter: 11 μm), 0.1 g of distilled water, 32.3 g of ethanol and 24.6 g of the polymer (H1) dispersion were added in a nitrogen atmosphere, mixed and crushed by a homogenizer. Then, 21.5 g of 1,1,2,2,3,3,4-heptafluorocyclopentane (manufactured by ZEON CORPORATION, ZEORORA H) was added, and well dispersed and mixed by a homogenizer to obtain a coating fluid (c3) for forming a catalyst layer.

(Coating Fluid (c4) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 47 mass % of the entire mass of the catalyst, and 7.4 g of carbon fibers (manufactured by Mitsubishi Plastics, Inc., Dialead K223QG, fiber diameter: 11 μm), 2.2 g of distilled water, 48.3 g of ethanol and 26.9 g of the polymer (H1) dispersion were added in a nitrogen atmosphere, mixed and crushed by a homogenizer. Then, 29.9 g of 1,1,2,2,3,3,4-heptafluorocyclopentane (manufactured by ZEON CORPORATION, ZEORORA H) was added, and well dispersed and mixed by a homogenizer to obtain a coating fluid (c4) for forming a catalyst layer.

(Coating Fluid (c5) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 37 mass % of the entire mass of the catalyst, and 2.2 g of carbon fibers (manufactured by Mitsubishi Plastics, Inc., Dialead K223QG, fiber diameter: 11 μm), 0.5 g of distilled water, 35.3 g of ethanol and 25.1 g of the polymer (H1) dispersion were added in a nitrogen atmosphere, mixed and crushed by a homogenizer. Then, 23.1 g of 1,1,2,2,3,3,4-heptafluorocyclopentane (manufactured by ZEON CORPORATION, ZEORORA H) was added, and well dispersed and mixed by a homogenizer to obtain a coating fluid (c5) for forming a catalyst layer.

(Coating Fluid (c6) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 31 mass % of the entire mass of the catalyst, and 3.5 g of carbon fibers (manufactured by Osaka Gas Chemicals Co., Ltd., DONACARBO Chop S-331, fiber diameter: 18 μm), 0.4 g of distilled water, 39.2 g of ethanol and 28.5 g of the polymer (H1) dispersion were added in a nitrogen atmosphere, mixed and crushed by a homogenizer. Then, 25.8 g of 1,1,2,2,3,3,4-heptafluorocyclopentane (manufactured by ZEON CORPORATION, ZEORORA H) was added, and well dispersed and mixed by a homogenizer to obtain a coating fluid (c6) for forming a catalyst layer.

(Coating Fluid (c7) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 39 mass % of the entire mass of the catalyst, and 3.1 g of carbon fibers (manufactured by Toray Industries, Inc., MLD1000, fiber diameter: 7 μm), 0.8 g of distilled water, 37.4 g of ethanol and 25.3 g of the polymer (H1) dispersion were added in a nitrogen atmosphere, mixed and crushed by a homogenizer. Then, 24.2 g of 1,1,2,2,3,3,4-heptafluorocyclopentane (manufactured by ZEON CORPORATION, ZEORORA H) was added, and well dispersed and mixed by a homogenizer to obtain a coating fluid (c7) for forming a catalyst layer.

(Coating Fluid (c8) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 33 mass % of the entire mass of the catalyst, and 13.4 g of carbon fibers (manufactured by Toray Industries, Inc., MLD1000, fiber diameter: 7 μm), 2.6 g of distilled water, 65.3 g of ethanol and 38.3 g of the polymer (H1) dispersion were added in a nitrogen atmosphere, mixed and crushed by a homogenizer. Then, 40.9 g of 1,1,2,2,3,3,4-heptafluorocyclopentane (manufactured by ZEON CORPORATION, ZEORORA H) was added, and well dispersed and mixed by a homogenizer to obtain a coating fluid (c8) for forming a catalyst layer.

(Coating Fluid (c9) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 37 mass % of the entire mass of the catalyst, and 7.6 g of carbon fibers (manufactured by Mitsubishi Plastics, Inc., Dialead K223QG, fiber diameter: 11 μm), 1.6 g of distilled water, 49.5 g of ethanol and 30.6 g of the polymer (H1) dispersion were added in a nitrogen atmosphere, mixed and crushed by a homogenizer. Then, 31.4 g of 1,1,2,2,3,3,4-heptafluorocyclopentane (manufactured by ZEON CORPORATION, ZEORORA H) was added, and well dispersed and mixed by a homogenizer to obtain a coating fluid (c9) for forming a catalyst layer.

(Coating Fluid (c10) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 20 mass % of the entire mass of the catalyst, and 4.0 g of carbon fibers (manufactured by Toray Industries, Inc., MLD1000, fiber diameter: 7 μm), 0.1 g of distilled water, 41.5 g of ethanol and 32.9 g of the polymer (H1) dispersion were added in a nitrogen atmosphere, mixed and crushed by a homogenizer. Then, 27.8 g of 1,1,2,2,3,3,4-heptafluorocyclopentane (manufactured by ZEON CORPORATION, ZEORORA H) was added, and well dispersed and mixed by a homogenizer to obtain a coating fluid (c10) for forming a catalyst layer.

(Coating Fluid (c11) for Forming a Catalyst Layer)

To 10.0 g of a carbon (specific surface area: 800 m²/g) supported platinum catalyst (manufactured by Tanaka Kikinzoku Kogyo K.K.) so that platinum was contained in an amount of 17 mass % of the entire mass of the catalyst, and 4.2 g of carbon fibers (manufactured by Toray Industries, Inc., MLD1000, fiber diameter: 7 μm), 0.1 g of distilled water, 42.1 g of ethanol and 34.1 g of the polymer (H1) dispersion were added in a nitrogen atmosphere, mixed and crushed by a homogenizer. Then, 28.4 g of 1,1,2,2,3,3,4-heptafluorocyclopentane (manufactured by ZEON CORPORATION, ZEORORA H) was added, and well dispersed and mixed by a homogenizer to obtain a coating fluid (c11) for forming a catalyst layer.

(Coating Fluid (c12) for Forming a Catalyst Layer)

To 14.2 g of a carbon (specific surface area: 800 m²/g) supported platinum catalyst (manufactured by Tanaka Kikinzoku Kogyo K.K.) so that platinum was contained in an amount of 12 mass % of the entire mass of the catalyst, 98.6 g of distilled water and 93.5 g of ethanol were added in a nitrogen atmosphere, and well stirred. Then, 35.7 g of the polymer (H1) dispersion was added, and well dispersed and mixed by a homogenizer to obtain a coating fluid (c12) for forming a catalyst layer.

### (Preparation of Anode)

Using a commercially available gas diffusion substrate provided with a microporous layer (manufactured by SGL Carbon Japan CO., LTD., GDL25BC), the coating fluid (a1) for forming a catalyst layer was applied on the surface of the microporous layer using a die coater so that the platinum loading in the catalyst layer after drying would be 0.2 mg/cm², and dried in a dryer at 80° C. for 30 minutes to form a catalyst layer thereby to obtain an anode (A1).

### Example 1

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c1) for forming a catalyst layer was applied using a die coater so that the platinum loading in the catalyst layer after drying would be 0.40 mg/cm², and the coating fluid (b1) for forming a catalyst layer was overlaid thereon so that the thickness of the CF catalyst layer after drying would be 50 μm and dried in a dryer at 80° C. for 30 minutes to form a CF catalyst layer thereby to obtain a laminate (L1). The cross section of the CF catalyst layer was observed using an electron microscope and as a result, the catalyst was contained in 30 μm from the film surface of the CF catalyst layer, and no catalyst was observed in 20 μm outside thereof.

A commercially available gas diffusion substrate (manufactured by SGL Carbon Japan CO., LTD., GDL25BC) was overlaid on the laminate (L1) so that the microporous layer was in contact with the CF catalyst layer of the laminate (L1), and they were bonded by hot pressing at a pressing temperature of 130° C. under a pressing pressure of 2 MPa, and then the substrate film was separated to obtain a laminate (GL1) provided with a gas diffusion layer.

The anode (A1) was overlaid on the laminate (GL1) provided with a gas diffusion layer so that the catalyst layer of the anode (A1) was in contact with the polymer electrolyte membrane of the laminate (GL1) provided with a gas diffusion layer, and they were bonded by hot pressing at a pressing temperature of 130° C. under a pressing pressure of 2 MPa to obtain a membrane/electrode assembly having an electrode area of 25 cm².

The obtained membrane/electrode assembly was assembled into a power generation cell so that the CF catalyst layer side corresponds to the cathode, and cell voltages at the initial stage of operation were measured. The results are shown in Table 1.

### Example 2

A laminate (L2) was obtained in the same manner as in Example 1 except that the coating fluid (c2) for forming a catalyst layer was used instead of the coating fluid (c1) for forming a catalyst layer and that the coating fluid (b3) for forming a catalyst layer was used instead of the coating fluid (b1) for forming a catalyst layer. The cross section of the CF catalyst layer was observed using an electron microscope and as a result, the catalyst was contained in 30 μm from the film surface of the CF catalyst layer, and no catalyst was observed in 20 μm outside thereof.

A membrane/electrode assembly having an electrode area of 25 cm² was prepared in the same manner as in Example 1 except that the laminate (L2) was used.

The obtained membrane/electrode assembly was assembled into a power generation cell so that the CF catalyst layer side corresponds to the cathode, and cell voltages at the initial stage of operation were measured. The results are shown in Table 1.

### Example 3

A laminate (L3) was obtained in the same manner as in Example 1 except that the coating fluid (c3) for forming a catalyst layer was used instead of the coating fluid (c1) for forming a catalyst layer and that the coating fluid (b3) for forming a catalyst layer was used instead of the coating fluid (b1) for forming a catalyst layer so that the thickness of the CF catalyst layer after drying would be 46 μm. The cross section of the CF catalyst layer was observed using an electron microscope and as a result, the catalyst was contained in 30 μm from the film surface of the CF catalyst layer, and no catalyst was observed in 16 μm outside thereof.

A membrane/electrode assembly having an electrode area of 25 cm² was prepared in the same manner as in Example 1 except that the laminate (L3) was used.

The obtained membrane/electrode assembly was assembled into a power generation cell so that the CF catalyst layer side corresponds to the cathode, and cell voltages at the initial stage of operation were measured. The results are shown in Table 1.

### Example 4

A laminate (L4) was obtained in the same manner as in Example 1 except that the coating fluid (c4) for forming a catalyst layer was used instead of the coating fluid (c1) for forming a catalyst layer and that the coating fluid (b3) for forming a catalyst layer was used instead of the coating fluid (b1) for forming a catalyst layer. The cross section of the CF catalyst layer was observed using an electron microscope and as a result, the catalyst was contained in 30 μm from the film surface of the CF catalyst layer, and no catalyst was observed in 20 μm outside thereof.

A membrane/electrode assembly having an electrode area of 25 cm² was prepared in the same manner as in Example 1 except that the laminate (L4) was used.

The obtained membrane/electrode assembly was assembled into a power generation cell so that the CF catalyst layer side corresponds to the cathode, and cell voltages at the initial stage of operation were measured. The results are shown in Table 1.

### Example 5

A laminate (L5) was obtained in the same manner as in Example 1 except that the coating fluid (c5) for forming a catalyst layer was used instead of the coating fluid (c1) for forming a catalyst layer and that the coating fluid (b3) for forming a catalyst layer was used instead of the coating fluid (b1) for forming a catalyst layer so that the thickness of the CF catalyst layer after drying would be 46 μm. The cross section of the CF catalyst layer was observed using an electron microscope and as a result, the catalyst was contained in 30 μm from the film surface of the CF catalyst layer, and no catalyst was observed in 16 μm outside thereof.

A membrane/electrode assembly having an electrode area of 25 cm² was prepared in the same manner as in Example 1 except that the laminate (L5) was used.

The obtained membrane/electrode assembly was assembled into a power generation cell so that the CF catalyst layer side corresponds to the cathode, and cell voltages at the initial stage of operation were measured. The results are shown in Table 1.

### Example 6

A laminate (L6) was obtained in the same manner as in Example 1 except that the coating fluid (c6) for forming a catalyst layer was used instead of the coating fluid (c1) for forming a catalyst layer and that the coating fluid (b3) for forming a catalyst layer was used instead of the coating fluid (b1) for forming a catalyst layer so that the thickness of the CF catalyst layer after drying would be 70 μm. The cross section of the CF catalyst layer was observed using an electron microscope and as a result, the catalyst was contained in 40 μm from the film surface of the CF catalyst layer, and no catalyst was observed in 30 μm outside thereof.

A membrane/electrode assembly having an electrode area of 25 cm² was prepared in the same manner as in Example 1 except that the laminate (L6) was used.

The obtained membrane/electrode assembly was assembled into a power generation cell so that the CF catalyst layer side corresponds to the cathode, and cell voltages at the initial stage of operation were measured. The results are shown in Table 1.

### Example 7

A laminate (L7) was obtained in the same manner as in Example 1 except that the coating fluid (c7) for forming a catalyst layer was used instead of the coating fluid (c1) for forming a catalyst layer and that the coating fluid (b3) for forming a catalyst layer was used instead of the coating fluid (b1) for forming a catalyst layer. The cross section of the CF catalyst layer was observed using an electron microscope and as a result, the catalyst was contained in 30 μm from the film surface of the CF catalyst layer, and no catalyst was observed in 20 μm outside thereof.

A membrane/electrode assembly having an electrode area of 25 cm² was prepared in the same manner as in Example 1 except that the laminate (L7) was used.

The obtained membrane/electrode assembly was assembled into a power generation cell so that the CF catalyst layer side corresponds to the cathode, and cell voltages at the initial stage of operation were measured. The results are shown in Table 1.

### Example 8

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c8) for forming a catalyst layer was applied using a die coater so that the platinum loading in the catalyst layer after drying would be 0.25 mg/cm², and the coating fluid (b2) for forming a catalyst layer was overlaid thereon so that the thickness of the CF catalyst layer after drying would be 40 μm and dried in a dryer at 80° C. for 30 minutes to form a CF catalyst layer thereby to obtain a laminate (L8). The cross section of the CF catalyst layer was observed using an electron microscope and as a result, the catalyst was contained in 36 μm from the film surface of the CF catalyst layer, and no catalyst was observed in 4 μm outside thereof.

A membrane/electrode assembly having an electrode area of 25 cm² was prepared in the same manner as in Example 1 except that the laminate (L8) was used.

The obtained membrane/electrode assembly was assembled into a power generation cell so that the CF catalyst layer side corresponds to the cathode, and cell voltages at the initial stage of operation were measured. The results are shown in Table 1.

### Example 9

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c9) for forming a catalyst layer was applied using a die coater so that the platinum loading in the catalyst layer after drying would be 0.30 mg/cm², and the coating fluid (b2) for forming a catalyst layer was overlaid thereon so that the thickness of the CF catalyst layer after drying would be 40 μm and dried in a dryer at 80° C. for 30 minutes to form a CF catalyst layer thereby to obtain a laminate (L9). The cross section of the CF catalyst layer was observed using an electron microscope and as a result, the catalyst was contained in 31 μm from the film surface of the CF catalyst layer, and no catalyst was observed in 9 μm outside thereof.

A membrane/electrode assembly having an electrode area of 25 cm² was prepared in the same manner as in Example 1 except that the laminate (L9) was used.

The obtained membrane/electrode assembly was assembled into a power generation cell so that the CF catalyst layer side corresponds to the cathode, and cell voltages at the initial stage of operation were measured. The results are shown in Table 1.

### Example 10

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c10) for forming a catalyst layer was applied using a die coater so that the platinum loading in the catalyst layer after drying would be 0.15 mg/cm², and the coating fluid (b5) for forming a catalyst layer was overlaid thereon so that the thickness of the CF catalyst layer after drying would be 40 μm and dried in a dryer at 80° C. for 30 minutes to form a CF catalyst layer thereby to obtain a laminate (L10). The cross section of the CF catalyst layer was observed using an electron microscope and as a result, the catalyst was contained in 25 μm from the film surface of the CF catalyst layer, and no catalyst was observed in 15 μm outside thereof.

A membrane/electrode assembly having an electrode area of 25 cm² was prepared in the same manner as in Example 1 except that the laminate (L10) was used.

The obtained membrane/electrode assembly was assembled into a power generation cell so that the CF catalyst layer side corresponds to the cathode, and cell voltages at the initial stage of operation were measured. The results are shown in Table 1.

### Example 11

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c11) for forming a catalyst layer was applied using a die coater so that the platinum loading in the catalyst layer after drying would be 0.10 mg/cm², and the coating fluid (b5) for forming a catalyst layer was overlaid thereon so that the thickness of the CF catalyst layer after drying would be 40 μm and dried in a dryer at 80° C. for 30 minutes to form a CF catalyst layer thereby to obtain a laminate (L11). The cross section of the CF catalyst layer was observed using an electron microscope and as a result, the catalyst was contained in 20 μm from the film surface of the CF catalyst layer, and no carbon supported platinum catalyst was observed in 20 μm outside thereof.

A membrane/electrode assembly having an electrode area of 25 cm² was prepared in the same manner as in Example 1 except that the laminate (L11) was used.

The obtained membrane/electrode assembly was assembled into a power generation cell so that the CF catalyst layer side corresponds to the cathode, and cell voltages at the initial stage of operation were measured. The results are shown in Table 1.

### Example 12

On the surface of a substrate film, the polymer (H1) dispersion was applied using a die coater so that the thickness after drying would be 30 μm and dried in a dryer at 80° C. for 30 minutes to form a polymer electrolyte membrane. On the surface of the polymer electrolyte membrane, the coating fluid (c12) for forming a catalyst layer was applied using a die coater so that the platinum loading in the catalyst layer after drying would be 0.10 mg/cm², and the coating fluid (b4) for forming a catalyst layer was overlaid thereon so that the thickness of the CF catalyst layer after drying would be 40 μm and dried in a dryer at 80° C. for 30 minutes to form a CF catalyst layer thereby to obtain a laminate (L12). The cross section of the CF catalyst layer was observed using an electron microscope and as a result, the catalyst was contained in 20 μm from the film surface of the CF catalyst layer, and no catalyst was observed in 20 μm outside thereof.

A membrane/electrode assembly having an electrode area of 25 cm² was prepared in the same manner as in Example 1 except that the laminate (L12) was used.

The obtained membrane/electrode assembly was assembled into a power generation cell so that the CF catalyst layer side corresponds to the cathode, and cell voltages at the initial stage of operation were measured. The results are shown in Table 1.

TABLE 1

| | CF catalyst layer on the cathode side | | | | Cell voltage (mV) | |
|---|---|---|---|---|---|---|
| | CF average | | Proportion of platinum | Platinum | Electric current | Electric current |
| | fiber diameter | Proportion of CF | on the membrane side | loading | density | density |
| | (μm) | (mass %) | (mass %) | (mg/cm²) | 0.2 A/cm² | 1.0 A/cm² |
| Ex. 1 | 0.15 | 72 | 83 | 0.4 | 767 | 595 |
| Ex. 2 | 11 | 87 | 83 | 0.4 | 767 | 590 |
| Ex. 3 | 11 | 58 | 77 | 0.4 | 768 | 603 |
| Ex. 4 | 11 | 80 | 83 | 0.4 | 773 | 628 |
| Ex. 5 | 11 | 63 | 77 | 0.4 | 773 | 630 |
| Ex. 6 | 18 | 71 | 88 | 0.4 | 772 | 614 |
| Ex. 7 | 11 | 70 | 83 | 0.4 | 783 | 645 |
| Ex. 8 | 6 | 71 | 55 | 0.25 | 776 | 625 |
| Ex. 9 | 6 | 70 | 65 | 0.3 | 780 | 637 |
| Ex. 10 | 7 | 67 | 80 | 0.15 | 775 | 628 |
| Ex. 11 | 7 | 75 | 100 | 0.1 | 774 | 620 |
| Ex. 12 | 11 | 75 | 100 | 0.1 | 772 | 618 |

CF: Carbon fibers
Proportion of CF: Proportion of carbon fibers to 100 mass % of carbon fibers and a carbon support.
Proportion of platinum on the membrane side: Proportion of platinum in half of the region on the polymer electrolyte membrane side of the CF catalyst layer.

### INDUSTRIAL APPLICABILITY

The membrane/electrode assembly of the present invention is useful as a membrane/electrode assembly for a polymer electrolyte fuel cell for stationary use, automobile use and so on.

The entire disclosure of Japanese Patent Application No. 2008-325863 filed on Dec. 22, 2008 including specification, claims, drawings and summary is incorporated herein by reference in its entirety.

What is claimed is:

1. A membrane/electrode assembly for a polymer electrolyte fuel cell, which comprises a first electrode having a catalyst layer, a second electrode having a catalyst layer and a polymer electrolyte membrane interposed between the first electrode and the second electrode in a state where it is in contact with the catalyst layers, wherein at least one of the catalyst layer of the first electrode and the catalyst layer of the second electrode is a carbon fiber catalyst layer which contains a carbon supported platinum catalyst, carbon fibers having an average fiber diameter of from 5 to 20 μm, and a fluorinated ion exchange resin, in a proportion of the carbon fibers of from 60 to 85 mass % to the total amount (100 mass %) of the carbon fibers and the carbon support.

2. The membrane/electrode assembly for a polymer electrolyte fuel cell according to claim 1, wherein the proportion of platinum in half of the region on the polymer electrolyte membrane side of the carbon fiber catalyst layer, is from 60 to 100 mass % of the amount of platinum contained in the entire carbon fiber catalyst layer.

3. The membrane/electrode assembly for a polymer electrolyte fuel cell according to claim 2, wherein the platinum loading in the carbon fiber catalyst layer is from 0.05 to 0.3 mg/cm².

4. A coating fluid for forming a catalyst layer for a polymer electrolyte fuel cell, which comprises a carbon supported platinum catalyst, carbon fibers having an average fiber diameter of from 5 to 20 μm, a fluorinated ion exchange resin, and a dispersion medium, wherein the dispersion medium contains a fluorinated solvent.

5. The coating fluid for forming a catalyst layer for a polymer electrolyte fuel cell according to claim 4, wherein the fluorinated solvent is 1,1,2,2,3,3,4-heptafluorocyclopentane.

6. The coating fluid for forming a catalyst layer for a polymer electrolyte fuel cell according to claim 4, wherein the fluorinated solvent is 2,2,3,3,3-pentafluoropropanol.

7. The coating fluid for forming a catalyst layer for a polymer electrolyte fuel cell according to claim 4, wherein the solid content concentration is from 10 to 50 mass %.

8. A process for producing a membrane/electrode assembly for a polymer electrolyte fuel cell comprising a first electrode having a catalyst layer, a second electrode having a catalyst layer and a polymer electrolyte membrane interposed between the first electrode and the second electrode in a state where it is in contact with the catalyst layers, which comprises applying the coating fluid for forming a catalyst layer for a polymer electrolyte fuel cell as defined in claim 4 on the surface of the polymer electrolyte membrane and drying the coating fluid to form at least one of the catalyst layer of the first electrode and the catalyst layer of the second electrode.
